(19) United States
(12) Patent Application Publication
(10) Pub. No.: US 2024/0221263 A1
(43) Pub. Date: Jul. 4, 2024

(54) SYSTEM AND METHOD FOR TRAINING AND USING AN IMPLICIT REPRESENTATION NETWORK FOR REPRESENTING THREE DIMENSIONAL OBJECTS

(71) Applicant: DE-IDENTIFICATION LTD., Tel Aviv (IL)

(72) Inventors: Or GORODISSKY, Tel Aviv (IL); Amitay NACHMANI, Tel Aviv (IL); Matan FELDMAN, Tel Aviv (IL); Eliran KUTA, Tel Aviv (IL); Gil PERRY, Tel Aviv (IL); Sella BLONDHEIM, Tel Aviv (IL)

(73) Assignee: DE-IDENTIFICATION LTD., Tel Aviv (IL)

(21) Appl. No.: 18/396,854

(22) Filed: Dec. 27, 2023

Related U.S. Application Data
(60) Provisional application No. 63/435,589, filed on Dec. 28, 2022.

(51) Int. Cl. G06T 13/40; G06T 17/00; G06V 10/54; G06V 40/16

(52) U.S. Cl. CPC G06T 13/40; G06T 17/00; G06V 10/54; G06V 40/174

(57) ABSTRACT

System and method for using an implicit representation network (IRN) for three-dimensional (3D) animation, including: training the IRN network together with an expression extraction network and an identity extraction network, wherein the expression extraction network is trained to generate an expression embedding from an input image of a face, the identity extraction network is trained to generate an identity embedding from the input image, and the IRN network is trained to obtain the expression embedding and the identity embedding and to generate an implicit 3D model of the face; and controlling at least one of the expression and identity of the implicit 3D model of the face by changing at least one of the identity embedding and the expression embedding.

### CROSS-REFERENCE TO RELATED APPLICATIONS

This application claims the benefit of U.S. Provisional Application Ser. No. 63/435,589, filed Dec. 28, 2022, which is hereby incorporated by reference in its entirety.

### FIELD OF THE INVENTION

Embodiments of the present invention relate generally to the field of computer graphics. More specifically, embodiments of the present invention relate training and using an implicit representation network for representing three dimensional objects.

### BACKGROUND

With the rise of virtual environments used in video games or immersive experiences, e.g., computerized three-dimensional (3D) images or scenes which appear to surround the user, such as virtual reality (VR) or mixed reality (XR), the need for detailed 3D representations of humans increases as well. Preferably, these 3D representations may be as detailed as possible, both in terms of the shape (e.g., the external form) and the texture (e.g., the external cover), and may allow controllability and integration into existing 3D engines. Reconstructing these high-quality representations from partial information of the subject is extremely useful, where information describing a 3D shape may be partial since it is taken from a collection of images, partial scans or a single image.

Implicit representation networks (IRN) may include a type of generative artificial intelligence (AI) or machine learning (ML) network that may represent complex signals, shapes or objects by predicting the local properties of the signal, shape or object at a queried continuous point. These models may describe complex 3D objects and priors, as well as represent high quality textures.

The implicit representations can vary from model to model and can be represented as a signed distance function, where the implicit network learns to regress the closest distance from the surface at each query point in the space. The sign of the distance indicates whether the query point is inside (e.g., negative) or outside (e.g., positive) of the shape. Other methods leverage a set of control points that form a grid, and each query point may get its value based on a set enclosing it.

### SUMMARY

According to embodiments of the invention, a computer-based system and method for training and inferring an IRN for 3D animation, may include: training the IRN network together with an expression extraction network and an identity extraction network, wherein the expression extraction network is trained to generate an expression embedding from an input image of a face, the identity extraction network is trained to generate an identity embedding from the input image, and the IRN network is trained to obtain the expression embedding and the identity embedding and to generate an implicit 3D model of the face: and controlling at least one of the expression and identity of the implicit 3D model of the face by changing at least one of the identity embedding and the expression embedding.

According to embodiments of the invention, changing the identity embedding may include providing a second input image of a face having a required identity to the identity extraction network and wherein changing the expression embedding comprises providing a second input image of a face having a required expression to the expression extraction network.

According to embodiments of the invention, the IRN network may further obtain a speech embedding generated from the input image of a face.

According to embodiments of the invention, the IRN network may include: an identity embedder being a network configured to obtain the identity embedding and generate an identity representation: an expression embedder being a network configured to obtain the expression embedding and the speech embedding generated from the input image of the face, and generate an expression representation: and a fuser being a network configured to obtain the identity representation and the expression representation, and generate a fused identity and expression representation.

According to embodiments of the invention, the IRN network may include: an identity embedder being a network configured to obtain the identity embedding and generate an identity representation: an expression embedder being a network configured to obtain the expression embedding and generate an expression representation: a fuser being a network configured to obtain the identity representation and the expression representation, and generate a fused identity and expression representation.

According to embodiments of the invention, converting the implicit 3D representation into an explicit 3D representation may include: a shape predictor being a network configured to obtain the fused identity and expression representation and predict the shape representation; and a texture field being a network configured to obtain the fused identity and expression representation F and the shape representation, and predict the texture representation.

According to embodiments of the invention, the shape representation may include a set of tuples {v_10, v_il, . . . v_ij} i:0→N describing at least one of a topology in 3D and a value of occupancy in vertices {v}ij.

According to embodiments of the invention, the value of occupancy may include a signed distance function (SDF) value of the implicit representation at the vertices {v} ij.

According to embodiments of the invention, training the IRN may be performed using a training dataset of facial images, wherein the dataset may include facial images extracted from a plurality of videoclips of a plurality of persons, with a plurality of viewpoints per identity and a plurality of timepoints per viewpoint.

According to embodiments of the invention, training the IRN may be performed using at least one of:
an adversarial loss term generated by rendering two-dimensional (2D) images from the 3D model of the face and applying a pre-trained discriminator that is trained on the domain of human face images on the 2D images,
a sync loss term generated by providing a sequence of input facial images taken from a speaking human in a videoclip, generating the implicit 3D representation of the face for each of the input facial images, generating an animation from the generated implicit 3D representations, and measuring a level of discrepancy between the generated animation and the original speech in the videoclip, and
a reconstruction loss term generated by calculating a distance function between an original 2D input facial image and the rendered 2D image, wherein the original input facial image and the rendered 2D image have same extrinsic camera parameters.

### BRIEF DESCRIPTION OF THE DRAWINGS

Non-limiting examples of embodiments of the disclosure are described below with reference to figures attached hereto that are listed following this paragraph. Dimensions of features shown in the figures are chosen for convenience and clarity of presentation and are not necessarily shown to scale.

The subject matter regarded as the invention is particularly pointed out and distinctly claimed in the concluding portion of the specification. The invention, however, both as to organization and method of operation, together with objects, features and advantages thereof, can be understood by reference to the following detailed description when read with the accompanying drawings. Embodiments of the invention are illustrated by way of example and not limitation in the figures of the accompanying drawings, in which like reference numerals indicate corresponding, analogous or similar elements, and in which:

FIG. 1 depicts a system for training and inferring an IRN to produce 3D animation, according to embodiment of the invention.

FIG. 2 depicts a system for training and inferring an IRN to produce 3D animation, according to embodiments of the invention.

FIG. 3 is a flowchart of a method for training and inferring an IRN to produce 3D animation, according to embodiment of the invention.

FIG. 4 shows a high-level block diagram of an exemplary computing device which may be used with embodiments of the present invention.

It will be appreciated that for simplicity and clarity of illustration, elements shown in the figures have not necessarily been drawn accurately or to scale. For example, the dimensions of some of the elements can be exaggerated relative to other elements for clarity, or several physical components can be included in one functional block or element.

### DETAILED DESCRIPTION

In the following detailed description, numerous specific details are set forth in order to provide a thorough understanding of the invention. However, it will be understood by those skilled in the art that the present invention can be practiced without these specific details. In other instances, well-known methods, procedures, and components, modules, units and/or circuits have not been described in detail so as not to obscure the invention.

According to embodiments of the invention, machine learning models disclosed herein, also referred herein as networks, may include one or more artificial neural networks (NN). NNs are mathematical models of systems made up of computing units typically called neurons (which are artificial neurons or nodes, as opposed to biological neurons) communicating with each other via connections, links or edges. In common NN implementations, the signal at the link between artificial neurons or nodes can be for example a real number, and the output of each neuron or node can be computed by function of the (typically weighted) sum of its inputs, such as a rectified linear unit (ReLU) function. NN links or edges typically have a weight that adjusts as learning or training proceeds typically using a loss or cost function, which may for example be a function describing the difference between a NN output and the ground truth (e.g., correct answer). The weight may increase or decrease the strength of the signal at a connection. Typically, NN neurons or nodes are divided or arranged into layers, where different layers can perform different kinds of transformations on their inputs and can have different patterns of connections with other layers. NN systems can learn to perform tasks by considering example input data, generally without being programmed with any task-specific rules, being presented with the correct output for the data, and self-correcting, or learning using the loss function. A NN may be configured or trained for a specific task, e.g., image processing, pattern recognition or classification. Training a NN for the specific task may involve adjusting these weights based on examples (e.g., labeled data included in the training dataset). Each neuron of an intermediate or last layer may receive an input signal, e.g., a weighted sum of output signals from other neurons, and may process the input signal using a linear and/or nonlinear function (e.g., an activation function). The results of the input and intermediate layers may be transferred to other neurons and the results of the output layer may be provided as the output of the NN. For example, in a NN algorithm known as the gradient descent algorithm, the results of the output layer may be compared to the labels of the samples in the training dataset, and a loss or cost function (such as the root-mean-square error) may be used to calculate a difference between the results of the output layer and the labels. The weights of some of the neurons may be adjusted using the calculated differences, in a process that iteratively minimizes the loss or cost until satisfactory metrics are achieved or satisfied. A processor, e.g., central processing units (CPU), graphical processing units or fractional graphical processing units (GPU) or tensor processing units (TPU) or a dedicated hardware device may perform the relevant calculations on the mathematical constructs representing the NN. As used herein a NN may include deep neural networks (DNN), convolutional neural networks (CNN), recurrent neural networks (RNN), long short-term memory networks (LSTM), probabilistic neural networks (PNN), time delay neural network (TDNN), deep stacking network (DSN), generative adversarial networks (GAN), etc. For example, a CNN can be a deep, feed-forward network, which includes one or more convolutional layers, fully connected layers, and/or pooling layers. CNNs are particularly useful for visual applications.

Some algorithms for training a NN model such as gradient descent may enable training the NN model using samples taken from a training dataset. Each sample may be fed into, e.g., provided as input to, the NN model and a prediction may be made. At the end of a training session, the resulting predictions may be compared to the expected output variables, and loss or cost function may be calculated. The loss or cost function is then used to train the NN model, e.g., to adjust the model weights, for example using backpropagation and/or other training methods. Embodiments of the invention may use a loss function. The loss function may be used in the training process to adjust weights and other parameters in the various networks in a back propagation process.

A digital image, also referred to herein simply as an image, may include a visual (e.g., optical) representation of physical objects, specifically, a face of a human, provided in any applicable digital and computer format. Images may include a simple 2D array or matrix of computer pixels, e.g., values representing one or more light wavelengths or one or more ranges of light wavelength, within the visible light, in specified locations, or any other digital representation, provided in any applicable digital format such as jpg, bmp, tiff, etc. A digital image may be provided in a digital image file containing image data.

A 3D head or face model may be a digital representation of a 3D human head, including a 3D mesh and full UV texture map used for animation purposes, e.g., for a 3D animation of the head. The model may further include a rig, e.g., a definition or representations of a digital skeleton that enables the 3D head model to move, e.g., defines how the face and mouth of the 3D head model move when the animated character speaks or how the 3D head model raises an eyebrow. The 3D head model may be provided in any applicable format including .blend .obj .c4d .3ds .max .ma and many more formats. The 3D mesh may refer to a digital collection of vertices, edges, and polygons (all are computerized mathematical constructs) that together define a computerized 3D object. The vertices are coordinates in the 3D space, the edges each connect two adjacent vertices, and the polygons each enclose adjacent edges to form the surface of the 3D object. A UV texture map may refer to a 2D representation of a 3D object, where the letters “U” and “V” denote the X and Y axes of the 2D representation, e.g., the 2D representation may correspond to the 3D model being unfolded and laid out flat on a 2D plain. The UV texture map may be used to generate a 3D model in a 3D modeling process, referred to as wrapping, by projecting the 2D representation (e.g., the UV texture map) onto the surface of the 3D model.

Currently, the 3D faces learned with an articulated model and expressions (FLAME) model is the most dominant 3D head model used. Its output is a discrete explicit 3D mesh representation (e.g., 3D vertices, edges, and polygons) of a human face, alongside blendshapes and joints which allow controllable shape (e.g., the external form), expression (a look on the model's face that conveys a particular emotion) and pose (e.g., a particular position of the head).

Another parallel area of research is implicit scene representation, implicit representation, or neural implicit representation, which aims to describe a scene by a continuous implicit function. The continuous implicit function should accurately represent the image signal. That is, if a system passes the implicit function a pixel coordinate and pixel shape (height, width) as input, the implicit function may output the correct value for that pixel (e.g., pixel value in whichever representation used, e.g., red, green and blue (RGB) or other). Neural implicit representations use an NN to implement or estimate the continuous implicit function. By training on discretely represented samples of the same signal, the NN may learn to estimate the underlying (continuous) function. The simplest implementation is a signed distance function (SDF), which predicts a per-coordinate distance value, defining a shape surface by observing a constant isosurface, e.g., a 3D surface representation of points with equal values, with DeepSDF being the first deep-learning NN based solution of that manner. The key advantage of implicit representations over explicit ones is their continuity, e.g., not being limited to a pre-allocated grid size, that enables a fine-detailed representation of a scene.

However, currently only explicit representations, mostly mesh objects, may be used by computer graphic engines, thus a conversion from implicit representation to an explicit model is beneficial to exploit an obtained high-resolution implicit representation. The most common algorithm to generate an explicit 3D model from an SDF representation is marching cubes, which iteratively goes over all voxels in the 3D grid, defines the isosurface passing through each voxel based on the SDF values of its vertices, to eventually generate an explicit mesh. The main drawback of marching cubes is its non-differentiability, preventing it from being directly used as part of a neural-network training pipeline, thus only a few differentiable algorithms wrapping it were developed.

Embodiments of the invention may provide a system and method for training and inferring an IRN, e.g., for representing 3D head model of a person, including shape (e.g., the external form) and texture (e.g., the external cover of the form, e.g., colour or hue). Embodiments of the invention may allow using a single trained network (e.g., the IRN) to represent varying face shapes, textures and expressions using a simple optimization process to find the latent vector (e.g., an ordered set of numbers or values), also referred to herein as an embedding, that best represents the input image. Embodiments of the invention may train an IRN on the domain of faces, create a controllable shape and expression representation, represent both texture and shape and incorporate speech condition to improve expression for the mouth area.

Embodiments of the invention may improve prior technology and provide an IRN for representing an implicit 3D head model, later to be used for generating a 3D face model, e.g., for generating the parameters for an explicit 3D face model. Thus, embodiments of the invention may improve the technology of computer animation by enabling the generation of a high-quality, fine-detailed 3D animatable avatar. The animatable 3D human head generated using embodiments of the invention may be useful for many commercial applications, including gaming, movie production, e-commerce, e-learning, video photography, face anonymization, etc.

The learnt avatar (e.g., the 3D face model) may be reenacted using input videos of other characters, e.g., make the generated 3D face model repeat movements of a 3D head in a video, by finding the latent vector of the 3D head in the video in each frame then applying them to the IRN to generate an avatar representation and rendering the outcomes.

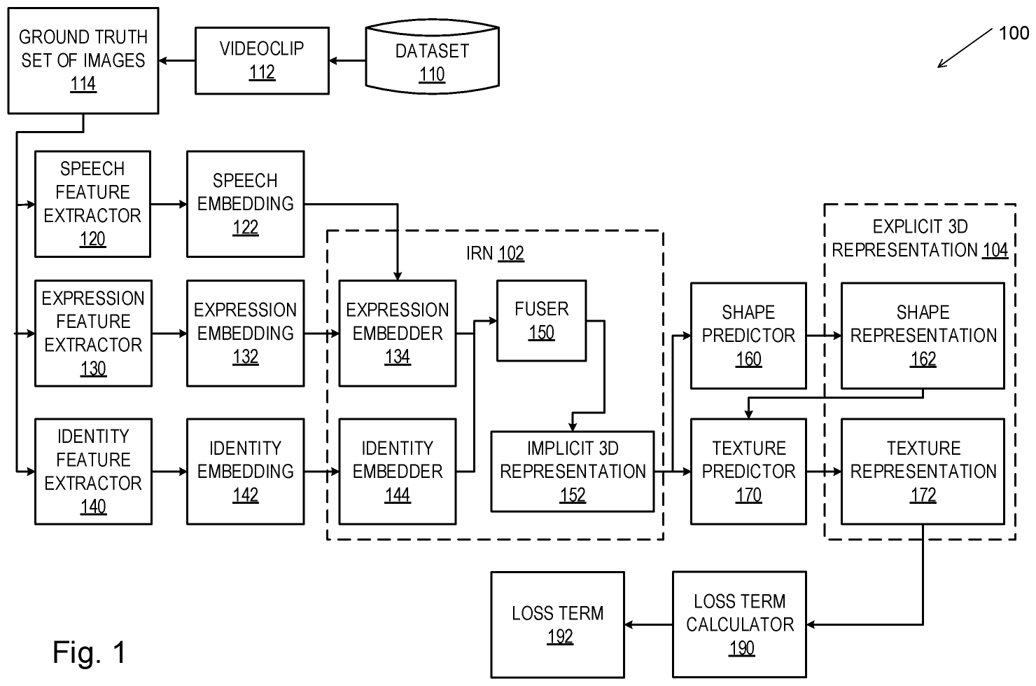

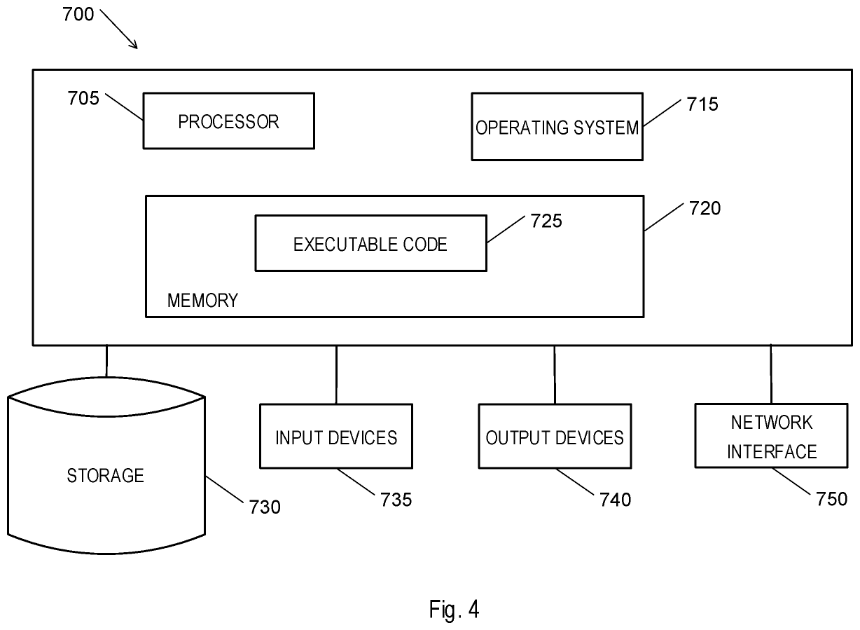

Reference is made to FIG. 1, which depicts a system 100 for training and inferring an IRN 102 to produce 3D animation, according to embodiments of the invention. It should be understood in advance that the components and functions, shown in FIG. 1 are intended to be illustrative only and embodiments of the invention are not limited thereto. While in some embodiments the system of FIG. 1 is implemented using systems as shown in FIG. 4, in other embodiments other systems and equipment can be used.

Dataset 110 may include a plurality of videoclips 112 (e.g., digital videoclips) of moving and talking heads, e.g., each videoclip 112 may include footage of a single talking head. The plurality of videoclips 112 may include videoclips 112 of different persons or identities. For example, videoclip 112 may include a shot or image sequence of a head of a person in which the person moves and speaks. To produce a single set of ground truth images 114, a videoclip 112 may be sampled over time to produce a plurality of time sequenced images that show the head from K viewpoints, and include T timestamped frames from each viewpoint, where K and T are natural numbers, typically larger than one. Multiple sets of ground truth images 114 may be generated, where each set 114 may be generated by sampling a videoclip 112, and where each set 114 may include a different person (identity) and a plurality of viewpoints per identity and a plurality of timepoints per viewpoint. Thus, a set of ground truth images 114 may represent a single person speaking, seen from different angle and at different time sequence. Each set in ground truth sets of digital images 114 may include images sampled from a single videoclip 112 at different times and the sampled images may be time stamped. Additionally or alternatively, dataset 110 may include a plurality of ground truth sets of images 114 themselves, e.g., after sampling. In some embodiments, dataset 110 may include a recording of the audio that represents the speech, e.g., a soundtrack of videoclip 112 that corresponds in time to the sampled images. The soundtrack may be time stamped as well.

For each training iteration, a ground truth set 114 of images of a face may be used. The set may be retrieved from dataset 110, or sampled from a videoclip 112 retrieved from dataset 110. As its name suggests, ground truth sets 114 of multi-view images may be the ground truth sets in the training process. In some embodiments, the images in ground truth set 114 may include constant view images, e.g., images of the same face taken from camera angles and head poses that are constant across ground truth sets 114. For example, in one embodiment, each ground truth set 114 may include a front images, a profile images, a top images and a back images of the face, where at least the a front images, a profile images include speech (e.g., includes a sequence of images taken while the person in the images was speaking). Other sets, with other number of images, taken from other angles and with different head poses, may be used.

The ground truth set 114 of images may be provided or fed into at least one of speech feature extractor 120, expression feature extractor 130, and identity feature extractor 140. Speech feature extractor 120 may include speech to representation algorithm S_in [t], e.g., a NN configured or pretrained to extract speech embedding from one or more images in ground truth set 114 of images. Speech feature extractor 120 may generate speech embedding 122, which may include a set of parameters that represent features of the input image (or plurality of input images) that are related to speech. Speech feature extractor 120 may include a pretrained NN, e.g., off-the-shelf or a propriety NN that is trained to extract speech related features from one or more input facial images, and the training of speech feature extractor 120 may be performed separately and prior to inclusion in system 100.

Expression feature extractor 130 may include an expression extraction network, e.g., a NN that may be trained to generate an expression embedding 132, E_in [t], also referred to as random expression feature, per timestamp (e.g., per a single image) from an input image of a face from ground truth set 114 of images. Expression feature extractor 130 may extract features related to expression from input facial images. Expression feature extractor 130 may be pretrained prior to inclusion in system 100, for an initial setting of weights of expression feature extractor 130. However, this is not mandatory. Expression feature extractor 130 may be further trained together with other networks in system 100 as disclosed herein.

Identity feature extractor 140 may include an identity extraction network, e.g., a NN that may be trained to generate an identity embedding 142 per identity I_in, also referred to as random identity feature, from an input image of a face or from a plurality of input images of the same person (same identity) from ground truth set 114 of images, e.g., identity feature extractor 140 may extract features related to identity from input facial images. Identity feature extractor 140 may be pretrained prior to inclusion in system 100, for an initial setting of weights of identity feature extractor 140. However, this is not mandatory. Identity feature extractor 140 may be further trained together with other networks in system 100 as disclosed herein.

At least one of speech embedding 122, expression embedding 132 and identity embedding 142 may be provided or fed into IRN 102, that may provide, calculate or produce an implicit 3D representation 152, also referred to as fused representation of the head of the person in ground truth set 114 of images (for a set of images of a single identity) or in one image from ground truth set 114 of images. Implicit 3D representation 152 may be any type of implicit 3D model type, including for example SDF models. Implicit 3D representation 152 (also referred to as an implicit 3D model) may be converted to an explicit 3D representation 104 (also referred to as an explicit 3D model) that may include shape representation 162 and texture representation 172 by shape predictor 160 and texture predictor 170. In some embodiments, explicit 3D representation 104 may provide specific types of 3D head models, e.g., a FLAME model or other types of 3D head models. Shape representation 162 may include a set of tuples {v_i0, v_il, . . . v_ij} i:0→N describing a topology in 3D and the value of occupancy in each of the vertices {v}ij, for example the SDF value (e.g., as provided in implicit 3D representation 152) at the vertices. Texture representation 172 may include the texture at the surface point, e.g., a UV texture map.

According to some embodiments, IRN 102 may include expression embedder 134, identity embedder 144 and fuser 150. In some embodiments, IRN 102 may include a single network. Identity embedder 144 may include a network configured to obtain identity embedding 142 and to generate an identity representation, e.g., an implicit representation of the identity. Expression embedder 134 may include a network configured to obtain expression embedding 132 and/or speech embedding 122 generated from the input image of the face and generate an expression representation. Fuser 150 may include a network or another algorithm configured to obtain the identity representation and the expression representation and fuse, unify or unite the identity representation and the expression representation into fused identity and expression representation, e.g., implicit 3D representation 152. Shape predictor 160 may include a network configured to obtain implicit 3D representation 152 and predict shape representation 162, also referred to as the shape values, of explicit head model 104, e.g., the set of tuples {v_10, v_il, . . . , v_ij} i:0→N describing a topology in 3D and the value of occupancy in each of the vertices {v} ij, for example the SDF value (e.g., as provided by the implicit 3D head representation 152) at the vertices. Texture predictor 170, also referred to as texture field, may include a network configured to obtain implicit 3D head representation 152 and shape representation 162, and predict texture representation 172, e.g., the texture at the surface point of the shape defined by shape representation 162, e.g., a UV texture map.

IRN 102 may be trained together with expression feature extractor 130, identity feature extractor 140, shape predictor 160 and texture predictor 170, e.g., the weights of IRN 102, expression feature extractor 130, identity feature extractor 140, shape predictor 160 and texture predictor 170 may updated, e.g., in accordance with the architecture of each network, using the same loss function, to minimize a global loss term 192 generated by loss term calculator 190. As used herein a loss term may refer to a part, summand or an expression included in a loss function. Loss term 192 may include, for example, one or more of the following sub loss terms (a loss function may include other terms):
An adversarial loss term: an adversarial loss term may be calculated for 2D images generated from explicit 3D representation 104. The 2D images may be generated from explicit 3D representation 104 using any known technique. One technique may include rendering 2D images from explicit 3D head model 104, e.g., by projecting the explicit 3D head model 104 onto a 2D image plane. Other methods may be used to render the 2D images from explicit 3D representation 104. The adversarial loss term may be generated, for example, using a pre-trained discriminator that was trained on the domain of human face images, or calculated based on the probabilities returned by the discriminator network. A discriminator in a generative adversarial network (GAN) may be or may include a classifier that may try to distinguish real data from the data created by the generator of the GAN, e.g., return the probability that the generated image is a real image. The discriminator may use any network architecture appropriate for classifying images. In this application, only the discriminator of a pretrained GAN network may be used for generating the adversarial loss term. Other classifiers may be used.
A synchronization (sync) loss term: a sync loss term may be generated by providing a sequence of input facial images from ground truth set of images 114, e.g., images taken from a speaking human in a videoclip 112, generating the explicit 3D representation 104 of the face for each of the input facial images, generating an animation from the generated 3D models, and measuring a level of discrepancy between the generated animation and the original speech, the audio recording in videoclip 112.
A reconstruction loss term— a reconstruction loss term may be generated by calculating a distance function between an original 2D input facial image from ground truth set of images 114 and the rendered 2D image, where the original input facial and the rendered 2D image have same extrinsic camera parameters (e.g. the same viewpoint). For example, the rendered 2D image may be rendered using a differentiable renderer or other type of renderer, that may render or derive a rendered 2D image having the same camera angle and head pose as the input image taken from the ground truth set 114. The reconstruction loss may measure how close the system output is to the original input and may be calculated or computed using a distance metric, e.g., mean-squared error (MSE), cross-entropy, L1 loss, e.g., the median absolute error (MAE), or L2 loss, e.g., the root mean squared error (RMSE).
A perceptual loss term— a perceptual loss term may be generated by comparing a rendered 2D image with a corresponding ground truth image from ground truth set 114, representing the same head poses. The perceptual loss may measure the difference between the high-level features of two images, e.g., a rendered 2D image and a corresponding image from ground truth set 114.

Loss term 192 may be used, e.g., may be included in a loss function, to jointly train IRN 102, expression feature extractor 130, and identity feature extractor 140, e.g., to adjust weights and other coefficients of IRN 102, expression feature extractor 130, and identity feature extractor 140, e.g., in a back propagation process. Other loss terms may be used.

During inference, parameters and weights of IRN 102, e.g., expression embedder 134, identity embedder 144 and fuser 150, as well as the parameters and weights of shape predictor 160 and texture predictor 170, may be kept constant (e.g., frozen), and only expression feature extractor 130 and identity feature extractor 140 may be trained using reconstruction loss. Once the network has converged, e.g., expression feature extractor 130 and identity feature extractor 140 are trained, explicit 3D representation 104, e.g., representation 162 and texture representation 172, may be controlled by changing the expression embedding 132 and/or the identity embedding 142. For example, the expression of explicit 3D representation 104 may be changed, manipulated or controlled by changing the expression embedding 132 and the identity of explicit 3D representation 104 may be changed, manipulated or controlled by changing the identity embedding 142. For example, the expression of explicit 3D representation 104 may be changed to fit a desired expression appearing in a 2D image of a face by providing or feeding the 2D image with the required expression to expression feature extractor 130 to generate the required expression embedding 132 and proving the generated expression embedding 132 to trained IRN 102. Similarly, the identity of explicit 3D representation 104 may be changed to fit a desired identity appearing in a 2D image of a face by providing or feeding the 2D image with the required identity (e.g., a new face) to identity feature extractor 140 to generate the required identity embedding 142 and proving the generated identity embedding 142 to trained IRN 102.

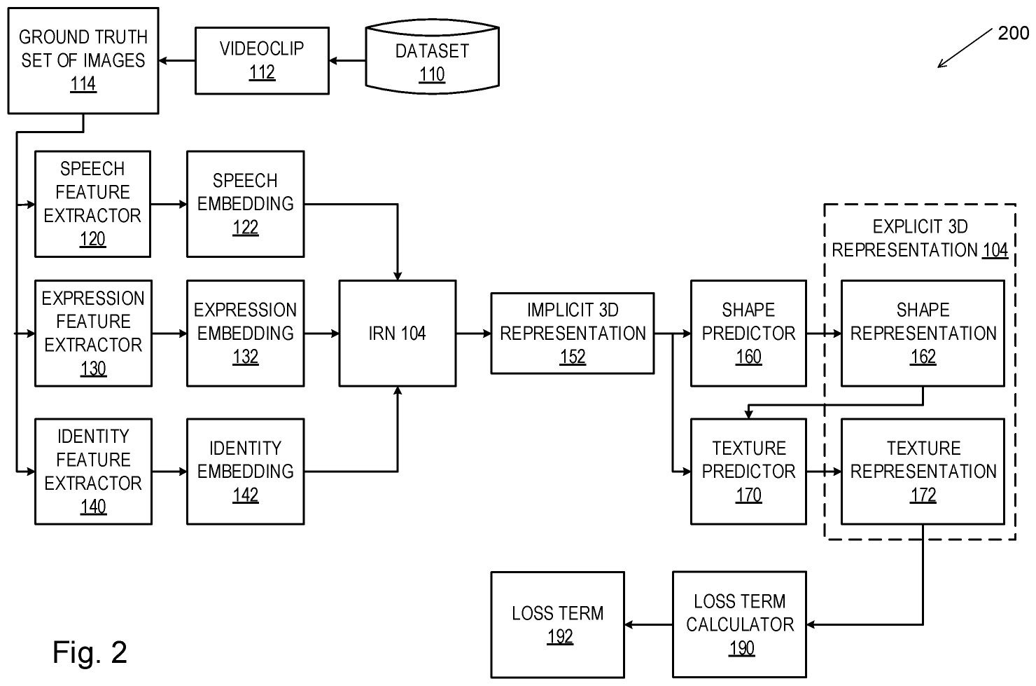

Reference is made to FIG. 2, which depicts a system 200 for training and inferring an IRN 104 to produce 3D animation, according to embodiments of the invention. It should be understood in advance that the components and functions, shown in FIG. 2 are intended to be illustrative only and embodiments of the invention are not limited thereto. While in some embodiments the system of FIG. 2 is implemented using systems as shown in FIG. 4, in other embodiments other systems and equipment can be used. Embodiments of system 200 may be similar to system 100, only IRN 104 in system 200 may be implemented as a single network instead of the three networks 134, 144 and 150 in system 100.

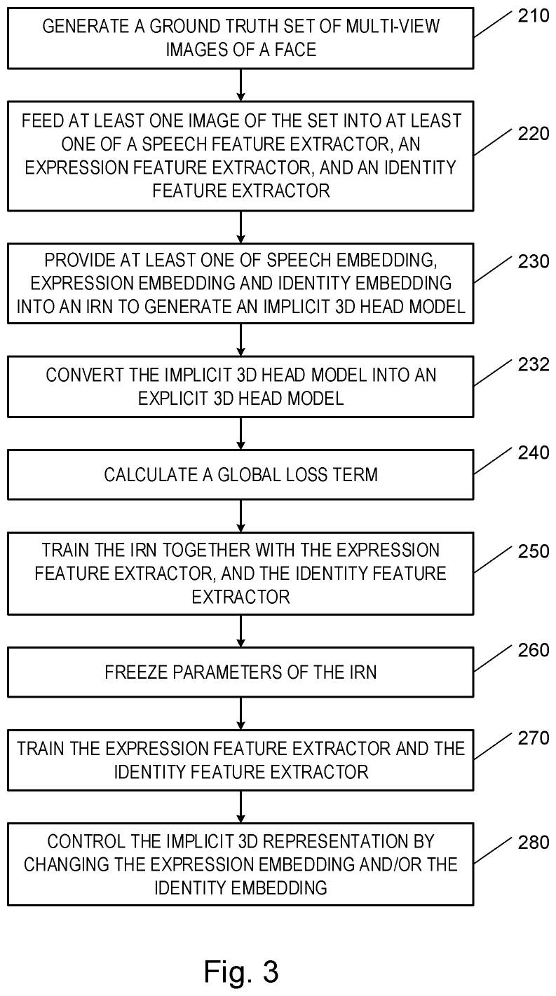

Reference is made to FIG. 3, which is a flowchart of a method for training and inferring an IRN to produce 3D animation, according to embodiments of the invention. While in some embodiments the operations of FIG. 3 are carried out using systems as shown in FIGS. 1, 2 and 4, in other embodiments other systems and equipment can be used.

In operation 210, a processor (e.g., processor 705 depicted in FIG. 4) may obtain or generate ground truth images of a face. The ground truth images may be sampled, for example, form a videoclip of a moving and/or speaking heads. In some embodiments, ground truth images for a single identity may include time sequenced images that show a head of a person from K viewpoints and include T timestamped frames from each viewpoint so that the set of ground truth images may represent a single person speaking over time, seen from different angles or viewpoints. The ground truth images may include images of a plurality of identities, with a plurality of viewpoints per identity and a plurality of timepoints per viewpoint. In operation 220, the processor may feed at least one image of the set of ground truth images into at least one of a speech feature extractor, an expression feature extractor, and an identity feature extractor, all of which a computerized modules including, for example, a NN. The speech feature extractor may be or may include a pre-trained NN configured or pretrained to extract speech embedding from one or more images in the ground truth set of images. The expression feature extractor may include an expression extraction network, e.g., a NN that may be trained to generate an expression embedding, also referred to as random expression feature, per timestamp (e.g., per a single image) from an input image of a face from the ground truth set of images. The identity feature extractor may include an identity extraction network, e.g., a NN that may be trained to generate an identity embedding per identity, also referred to as random identity feature, from an input image of a face or from a plurality of input images of the same person (same identity) from the ground truth set of images.

In operation 230, the processor may provide at least one of speech embedding, expression embedding and identity embedding into an IRN that may provide, calculate or produce an implicit 3D representation of the head of the person in the ground truth images. The implicit 3D representation may include the SDF values or other types of implicit 3D models. According to some embodiments, the IRN may include an expression embedder, an identity embedder and a fuser. According to some embodiments, the IRN may include a single network. The identity embedder may include a network configured to obtain the identity embedding and generate an identity representation, e.g., an implicit representation of the identity. The expression embedder may include a network configured to obtain the expression embedding and/or the speech embedding generated from the input image of the face and generate an expression representation. The fuser may include a network or another algorithm configured to obtain the identity representation and the expression representation and fuse, unify or unite the identity representation and the expression representation into the implicit 3D head model, which may include a fused identity and expression representation. In operation 232, the processor may convert the implicit 3D head model into an explicit 3D head model, e.g., using a shape predictor and a texture predictor. Other methods for converting the implicit 3D head model into an explicit 3D head model may be used. The shape predictor may include a network configured to obtain the fused identity and expression representation and predict the shape representation, e.g., a set of tuples {v_i0, v_il, . . , v_ij} i:0→N describing a topology in 3D and the value of occupancy in each of the vertices {v}ij, for example the SDF value at the vertices. The texture predictor may include a network configured to obtain the fused identity and expression representation and the shape representation, and predict the texture representation, e.g., a UV texture map including the texture at the surface point of the shape as defined by the shape representation.

In operation 240, the processor may calculate a global loss term that may include one or more of an adversarial loss term, a sync loss term, a reconstruction loss term and a perceptual loss term, as disclosed herein. In operation 250, the processor may jointly train the IRN with the expression feature extractor, the identity feature extractor, the shape predictor and the texture predictor. Training may continue until a stop criteria is met, as known in the art. In operation 260, the processor may freeze parameters of the IRN, e.g., keep the weights of the IRN constant. In operation 270, the processor may train the expression feature extractor and the identity feature extractor using reconstruction loss, until the network converges. In operation 280, the processor may control the implicit 3D representation and the explicit 3D representation, by changing the expression embedding and/or the identity embedding, as disclosed herein.

FIG. 4 shows a high-level block diagram of an exemplary computing device which may be used with embodiments of the present invention. Computing device 700 may include a controller or processor 705 that may be or include, for example, one or more central processing unit processor(s) (CPU), one or more Graphics Processing Unit(s) (GPU), a chip or any suitable computing or computational device, an operating system 715, a memory 720, a storage 730, input devices 735 and output devices 740. Each of modules and equipment such as systems 100 and 200 and other modules or equipment mentioned herein may be or include, or may be executed by, a computing device such as included in FIG. 4 or specific components of FIG. 4, although various units among these entities may be combined into one computing device.

Operating system 715 may be or may include any code segment designed and/or configured to perform tasks involving coordination, scheduling, supervising, controlling or otherwise managing operation of computing device 700, for example, scheduling execution of programs. Memory 720 may be or may include, for example, a Random Access Memory (RAM), a read only memory (ROM), a Dynamic RAM (DRAM), a volatile memory, a non-volatile memory, a cache memory, or other suitable memory units or storage units. Memory 720 may be or may include a plurality of possibly different memory units. Memory 720 may store for example, instructions to carry out a method (e.g., code 725), and/or data such as model weights, etc.

Executable code 725 may be any executable code, e.g., an application, a program, a process, task or script. Executable code 725 may be executed by processor 705 possibly under control of operating system 715. For example, executable code 725 may when executed carry out methods according to embodiments of the present invention. For the various modules and functions described herein, one or more computing devices 700 or components of computing device 700 may be used. One or more processor(s) 705 may be configured to carry out embodiments of the present invention by for example executing software or code.

Storage 730 may be or may include, for example, a hard disk drive, a floppy disk drive, a Compact Disk (CD) drive, or other suitable removable and/or fixed storage unit. Data such as instructions, code, images, training data, NN weights and parameters etc. may be stored in a storage 730 and may be loaded from storage 730 into a memory 720 where it may be processed by processor 705. Some of the components shown in FIG. 4 may be omitted.

Input devices 735 may be or may include for example a mouse, a keyboard, a touch screen or pad or any suitable input device. Any suitable number of input devices may be operatively connected to computing device 700 as shown by block 735. Output devices 740 may include displays, speakers and/or any other suitable output devices. Any suitable number of output devices may be operatively connected to computing device 700 as shown by block 740. Any applicable input/output (I/O) devices may be connected to computing device 700, for example, a modem, printer or facsimile machine, a universal serial bus (USB) device or external hard drive may be included in input devices 735 or output devices 740. Network interface 750 may enable device 700 to communicate with one or more other computers or networks. For example, network interface 750 may include a wired or wireless NIC.

Embodiments of the invention may include one or more article(s) (e.g. memory 720 or storage 730) such as a computer or processor non-transitory readable medium, or a computer or processor non-transitory storage medium, such as for example a memory, a disk drive, or a USB flash memory, encoding, including or storing instructions, e.g., computer-executable instructions, which, when executed by a processor or controller, carry out methods disclosed herein.

One skilled in the art will realize the invention may be embodied in other specific forms using other details without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein. In some cases well-known methods, procedures, and components, modules, units and/or circuits have not been described in detail so as not to obscure the invention. Some features or elements described with respect to one embodiment can be combined with features or elements described with respect to other embodiments.

Although embodiments of the invention are not limited in this regard, discussions utilizing terms such as, for example, “processing,” “computing,” “calculating,” “determining,” “establishing”, “analyzing”, “checking”, or the like, can refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that can store instructions to perform operations and/or processes.

Although embodiments of the invention are not limited in this regard, the terms “plurality” can include, for example, “multiple” or “two or more”. The term set when used herein can include one or more items. Unless explicitly stated, the method embodiments described herein are not constrained to a particular order or sequence. Additionally, some of the described method embodiments or elements thereof can occur or be performed simultaneously, at the same point in time, or concurrently.

What is claimed is:

1. A method for using an implicit representation network (IRN) to produce three-dimensional (3D) animation, the method comprising:
training the IRN together with an expression extraction network and an identity extraction network, wherein the expression extraction network is trained to generate an expression embedding from an input image of a face, the identity extraction network is trained to generate an identity embedding from the input image, and the IRN is trained to obtain the expression embedding and the identity embedding and to generate an implicit 3D representation of the face; and
controlling at least one of the expression and identity of the implicit 3D representation of the face by changing at least one of the identity embedding and the expression embedding.

2. The method of claim 1, wherein changing the identity embedding comprises providing a second input image of a face having a required identity to the identity extraction network and wherein changing the expression embedding comprises providing a second input image of a face having a required expression to the expression extraction network.

3. The method of claim 1, wherein the IRN further obtains a speech embedding generated from the input image of a face.

4. The method of claim 3, wherein the IRN comprises:
an identity embedder being a network configured to obtain the identity embedding and generate an identity representation;
an expression embedder being a network configured to obtain the expression embedding and the speech embedding generated from the input image of the face, and generate an expression representation; and
a fuser being a network configured to obtain the identity representation and the expression representation and generate a fused identity and expression representation.

5. The method of claim 1, wherein the IRN comprises:
an identity embedder being a network configured to obtain the identity embedding and generate an identity representation;
an expression embedder being a network configured to obtain the expression embedding and generate an expression representation;
a fuser being a network configured to obtain the identity representation and the expression representation and generate a fused identity and expression representation.

6. The method of claim 5, comprising converting the implicit 3D representation into an explicit 3D representation by:
a shape predictor being a network configured to obtain the fused identity and expression representation and predict a shape representation; and
a texture field being a network configured to obtain the fused identity and expression representation F and the shape representation and predict a texture representation.

7. The method of claim 6, wherein the shape representation comprises a set of tuples {v_i0, v_il, . . . v_ij} i:0→N describing at least one of a topology in 3D and a value of occupancy in vertices {v} ij.

8. The method of claim 7, wherein the value of occupancy comprises a signed distance function (SDF) value of the implicit representation at the vertices {v}ij.

9. The method of claim 1, wherein training the IRN is performed using a training dataset of facial images, wherein the dataset comprises facial images extracted from a plurality of videoclips of a plurality of persons, with a plurality of viewpoints per identity and a plurality of timepoints per viewpoint.

10. The method of claim 9, wherein training the IRN is performed using at least one of:
an adversarial loss term generated by rendering two-dimensional (2D) images from the 3D model of the face and applying a pre-trained discriminator that is trained on the domain of human face images on the 2D images,
a sync loss term generated by providing a sequence of input facial images taken from a speaking human in a videoclip, generating the implicit 3D representation of the face for each of the input facial images, generating an animation from the generated implicit 3D representations, and measuring a level of discrepancy between the generated animation and the original speech in the videoclip, and
a reconstruction loss term generated by calculating a distance function between an original 2D input facial image and the rendered 2D image, wherein the original input facial image and the rendered 2D image have same extrinsic camera parameters.

11. A system for using an implicit representation network (IRN) for three-dimensional (3D) animation, the system comprising:
a memory; and
a processor configured to:
train the IRN together with an expression extraction network and an identity extraction network, wherein the expression extraction network is trained to generate an expression embedding from an input image of a face, the identity extraction network is trained to generate an identity embedding from the input image, and the IRN is trained to obtain the expression embedding and the identity embedding and to generate an implicit 3D representation of the face; and
control at least one of the expression and identity of the implicit 3D representation of the face by changing at least one of the identity embedding and the expression embedding.

12. The system of claim 11, wherein the processor is configured to change the identity embedding by providing a second input image of a face having a required identity to the identity extraction network and wherein to change the expression embedding by providing a second input image of a face having a required expression to the expression extraction network.

13. The system of claim 11, wherein the IRN further obtains a speech embedding generated from the input image of a face.

14. The system of claim 13, wherein the IRN comprises:
an identity embedder being a network configured to obtain the identity embedding and generate an identity representation;
an expression embedder being a network configured to obtain the expression embedding and the speech embedding generated from the input image of the face, and generate an expression representation; and
a fuser being a network configured to obtain the identity representation and the expression representation and generate a fused identity and expression representation.

15. The system of claim 11, wherein the IRN comprises:
an identity embedder being a network configured to obtain the identity embedding and generate an identity representation;
an expression embedder being a network configured to obtain the expression embedding and generate an expression representation;
a fuser being a network configured to obtain the identity representation and the expression representation and generate a fused identity and expression representation.

16. The system of claim 15, wherein the processor is configured to convert the implicit 3D representation into an explicit 3D representation by:
a shape predictor being a network configured to obtain the fused identity and expression representation and predict a shape representation; and
a texture field being a network configured to obtain the fused identity and expression representation F and the shape representation and predict a texture representation.

17. The system of claim 16, wherein the shape representation comprises a set of tuples {v_i0, v_il, . . . v_ij} i:0→N describing at least one of a topology in 3D and a value of occupancy in vertices {v} ij.

18. The system of claim 17, wherein the value of occupancy comprises a signed distance function (SDF) value of the implicit representation at the vertices {v}ij.

19. The system of claim 11, wherein the processor is configured to train the IRN using a training dataset of facial images, wherein the dataset comprises facial images extracted from a plurality of videoclips of a plurality of persons, with a plurality of viewpoints per identity and a plurality of timepoints per viewpoint.

20. The system of claim 19, wherein the processor is configured to train the IRN using at least one of:
an adversarial loss term generated by rendering two-dimensional (2D) images from the 3D model of the face and applying a pre-trained discriminator that is trained on the domain of human face images on the 2D images,
a sync loss term generated by providing a sequence of input facial images taken from a speaking human in a videoclip, generating the implicit 3D representation of the face for each of the input facial images, generating an animation from the generated implicit 3D representations, and measuring a level of discrepancy between the generated animation and the original speech in the videoclip, and
a reconstruction loss term generated by calculating a distance function between an original 2D input facial image and the rendered 2D image, wherein the original input facial image and the rendered 2D image have same extrinsic camera parameters.
